(19) United States
(12) Patent Application Publication
(10) Pub. No.: US 2011/0003036 A1
(43) Pub. Date: Jan. 6, 2011

(54) Combined drink and dressing

(76) Inventor: Massimiliano Pineschi, Villanova (IT)

Correspondence Address: Themis Law, 7979 Ivanhoe Ave Ste 400, La Jolla, CA, 92037, US

(21) Appl. No.: 12/921,391

(22) PCT Filed: Mar. 11, 2009
(86) PCT No.: PCT/IB09/51004

§ 371 Date: Sep. 9, 2010

(30) Foreign Application Priority Data
Mar. 11, 2008 (IT) MO2008A000070

(51) Int. Cl. C12J 1/04; C12J 1/00

(52) U.S. Cl. 426/72; 426/589; 426/106

(57) ABSTRACT

The beverage-condiment comprises a first amount of balsamic vinegar and a second amount of a mixing liquid, wherein said mixing liquid comprises an alcoholic liquid, and optionally a third amount of a mixing liquid, such as water.

### FIELD OF THE INVENTION

The invention relates to a beverage-condiment, particularly pleasant when consumed as a digestive bitter or as a tonic or when used as a condiment for food.

### BACKGROUND OF THE INVENTION

A large number of components are used in the field of beverages to obtain beverages with particular and pleasant tastes.

Furthermore, a beverage is often required to be used for various purposes, also as a condiment for food, i.e. to impart particular flavors thereto.

Particularly, vinegar is known to be a liquid derived from the production of alcoholic beverages such as wine, cider and bier, whose fermentation allows ethanol contained therein to oxidize and be converted into acetic acid, which imparts an acidulous and rough flavor to the liquid, which flavor is then transferred to the seasoned food, in proportion to the amount of condiment being used.

The family of vinegars also includes balsamic vinegar, which is obtained from a sugary liquid instead of an alcoholic liquid like conventional vinegar.

This vinegar has a substantially less rough and acidulous taste than normal vinegar and is suitable for barrel ageing.

By being kept for a long time in barrels, during the so-called ageing process, balsamic vinegar becomes valuable and prized by the most demanding connoisseurs for use in the preparation of any kind of food.

Due to its organoleptic properties, balsamic vinegar is typically used for seasoning vegetables, salted food or desserts, where it creates a pleasant contrast of bitter-sweet tastes, and as a condiment for meat.

Certain producers have even used balsamic vinegar as a filling for sweets, such as candies and chocolates, to create a pleasant contrast of the sweet taste of the container and the rough taste of the filling.

Nevertheless, there is no knowledge of balsamic vinegar used as a beverage, not even mixed with other beverages or liquids to soften its rough taste.

### OBJECTS OF THE INVENTION

One object of the present invention is to improve the prior art by providing a beverage-condiment that uses balsamic vinegar as a component and softens its taste.

A further object of the invention is to provide a beverage-condiment that can be consumed in various forms, e.g. in liquid form as a tonic or a digestive or in dense form as a condiment.

In one aspect, the invention relates to a beverage-condiment comprising a first amount of balsamic vinegar and a second amount of a mixing liquid, characterized in that said mixing liquid comprises an alcoholic liquid.

In another aspect, the invention relates to a beverage-condiment comprising a first amount of balsamic vinegar and a second amount of a mixing liquid, characterized in that said mixing liquid comprises a liqueur obtained by soaking fruit in alcohol.

In yet another aspect, the invention relates to a beverage-condiment comprising a first amount of balsamic vinegar and a second amount of a mixing liquid, characterized in that said mixing liquid comprises a liqueur obtained by soaking walnut hulls in alcohol, the so-called “Nocino”.

The beverage-condiment of the present invention is particularly pleasant and adapted to be consumed in various forms, as a digestive, as a tonic and as a condiment, by simply slightly varying the amounts of balsamic vinegar, nocino and possibly water, which are their main components.

### EMBODIMENTS OF THE INVENTION

Further characteristics and advantages of the invention will appear more clearly from the description of a beverage-condiment obtained from mix recipes with certain amounts of balsamic vinegar and of a mixing liquor, namely Nocino, as detailed in the following examples that are provided by way of illustration and without limitation.

A volume of 0.25 liters of a beverage-condiment to be consumed as a tonic-energy drink may be obtained by mixing together the following components:
a. 150 cc pure water;
b. 50 cc Nocino;
c. 50 cc concentrated balsamic vinegar;
d. 1 g Taurine;
e. 0.1 g caffeine;
f. 1.25 g vitamin C.

A volume of 0.75 liters of a beverage-condiment to be consumed as a digestive may be obtained by mixing together the following components:
a. 562.5 cc Nocino;
b. 75 cc walnut hull extract;
c. 112.5 cc concentrated balsamic vinegar.

A volume of 0.25 liters of a beverage-condiment to be consumed as a condiment may be obtained by mixing together the following components:
a. 200 cc concentrated balsamic vinegar;
b. 50 cc Nocino.

The term balsamic vinegar is intended to indicate commercial grade balsamic vinegar (“non tradizionale”) made in Modena or Reggio Emilia, traditional balsamic vinegar (“tradizionale”) made in Modena or Reggio Emilia, and balsamic vinegar-based condiment (“condimento”).

What is claimed is:

1. A beverage-condiment comprising:
a first amount of balsamic vinegar; and
a second amount of a mixing liquid, wherein said mixing liquid comprises an alcoholic liquid.

2. The beverage-condiment as claimed in claim 1, wherein said mixing liquid comprises a liqueur obtained by soaking at least one fruit in alcohol.

3. The beverage-condiment as claimed in claim 2, wherein said mixing liquid comprises a liqueur obtained by soaking walnut hulls in alcohol, known as “Nocino”.

4. The beverage-condiment as claimed in claim 1, wherein said first amount is 10 cc to 200 cc.

5. The beverage-condiment as claimed in claim 1, wherein said second amount is 10 cc to 600 cc.

6. The beverage-condiment as claimed in claim 1, wherein the beverage-condiment is in a digestive form and further comprises 20 cc to 100 cc of an extract of at least one fruit.

7. The beverage-condiment as claimed in claim 1, wherein the beverage-condiment is in a tonic-energy drink form and further comprises 50 cc to 200 cc of water.

8. The beverage-condiment as claimed in claim 1, wherein the beverage-condiment is in a tonic-energy drink form and further comprises 50 cc to 200 cc of fruit juice.

9. The beverage-condiment as claimed in claim 7, further comprising a water-soluble and/or lipid-soluble vitamin element.

10. The beverage-condiment as claimed in claim 9, wherein said vitamin element is selected at least between a water-soluble and/or lipid-soluble vitamin added with Taurine and caffeine.

11. The beverage-condiment as claimed in claim 1, wherein the beverage-condiment is in a condiment form and has the density of a glaze.

12. The beverage-condiment as claimed in claim 1, wherein the beverage-condiment is in a digestive form and comprises, for a volume of 0.75 liters, a mixture of:
400 cc to 600 cc Nocino;
20 cc to 100 cc walnut extract; and
10 cc to 200 cc balsamic vinegar.

13. The beverage-condiment as claimed in claim 1, wherein the beverage-condiment is in a tonic-energy drink form and comprises, for a volume of 0.25 liters, a mixture of:
50 cc to 200 cc water;
10 cc to 100 cc Nocino; and
10 cc to 100 cc balsamic vinegar.

14. The beverage-condiment as claimed in claim 1, wherein the beverage-condiment is in a condiment form and comprises, for a volume of 0.25 liters, a mixture of:
50 cc to 200 cc balsamic vinegar; and
10 cc to 100 cc Nocino.

15. The beverage-condiment as claimed in claim 1, wherein the beverage-condiment is in a condiment form and has a density substantially similar to the density of a glaze.

16. The beverage-condiment as claimed in claim 15, wherein in said condiment form the beverage-condiment is configured to be placed in a squeezable package.

17. The beverage-condiment as claimed in claim 15, wherein said squeezable package comprises one or more of single or multi-dose packages.
